(19) United States
(12) Patent Application Publication
(10) Pub. No.: US 2015/0171492 A1
(43) Pub. Date: Jun. 18, 2015

(54) BATTERY ASSEMBLY

(71) Applicant: Robert Bosch GmbH, Stuttgart, DE (DE)

(72) Inventors: Reiner Ramsayer, Rutesheim (DE); Christof Kobler, Stuttgart (DE); Sonja Dudziak, Bietingheim-Bissingen (DE)

(73) Assignee: Robert Bosch GmbH, Stuttgart (DE)

(21) Appl. No.: 14/401,712

(22) PCT Filed: Apr. 12, 2013
(86) PCT No.: PCT/EP2013/057683

§ 371 Date: Nov. 17, 2014

(30) Foreign Application Priority Data
May 16, 2012 (DE) 10 2012 208 239.5

(51) Int. Cl. H01M 10/6551

(52) U.S. Cl. CPC H01M 10/5046

(57) ABSTRACT

A battery assembly, including multiple battery cells, which are electrically connected to one another and each of which includes a prismatic cell housing. Each cell housing has at least one fastening protrusion on a cell bottom, this fastening protrusion, protruding through an opening of a cooling element, which is configured as a cooling plate or as a cooling housing for the cell housings, the fastening protrusion cooperating with a clamping element, which clamps the cell housing against the cooling element.

### FIELD OF THE INVENTION

The present invention relates to a battery assembly.

### BACKGROUND INFORMATION

A battery assembly is discussed in DE 10 2010 029 872 A1. It is provided for use in a hybrid vehicle there and includes a plurality of mechanically and electrically interconnected prismatic cell housings, each forming individual battery cells. At high discharge currents and relatively high ambient temperatures in particular, the heat loss generated during discharge of the battery cells must be dissipated effectively to prevent thermal overload and damage to the battery cells. It is therefore known from the publication cited above that the cell housings together with their cell bottoms facing a cooling plate may be situated all-over in heat-conducting contact with the cooling plate. The known cell housings therefore have protrusions which protrude through passages in the cooling plate and are clamped against the cooling plate by applying an axial tensile force. Clamping elements in the form of plastic rails, which cooperate with rivet-type protrusions on the fastening protrusions, are provided for this purpose.

In addition, it is believed to be understood from the publication cited above that an intermediate layer having poor thermal conductivity properties may be provided between the cooling element and the cell bottoms of the cell housings. Thus the heat flow transferable from the battery cells to the cooling element is to be limited, and any dimensional tolerances, which might exist between the battery cells and the cooling element, are to be compensated for.

### SUMMARY OF THE INVENTION

An object of the present invention is to provide a battery having improved electrical insulation of the battery cells with respect to the cooling element.

According to the present invention, this object may be achieved by a battery assembly having the features described herein, in that the cell bottom is additionally electrically insulated with respect to the cooling element in addition to an optional coating of the cell housing and/or the cooling element. By providing the additional electrical insulation according to the present invention, a particularly secure and reliable electrical insulation of the cooling element with respect to the cell housings is made possible. Therefore, any damage to the cells or the cooling element which might be present due to a low-quality coating, for example, may be compensated for in particular or will not result in negative effects on the electrical properties of the battery assembly.

However, in addition to a good heat transfer between the battery cells and the cooling element, it also may be necessary in practice to provide a good and reliable electrical insulation between the battery cells and the cooling element. It must be considered here that the battery cells must be insulated among each other only with an insulation on the order of magnitude of the cell voltage (a few volts), but the insulation of the battery cell with respect to the cooling element must be on the order of magnitude of the battery system voltage (several hundred volts). It is believed to be understood from the related art that cell housings and cooling elements may be provided with a coating, which functions as electrical insulation, but such insulation is not yet optimized in the case of the required electrical insulation of the battery cells with respect to the cooling element in particular, which should be on the order of magnitude of a few hundred volts.

Advantageous refinements of the battery assembly according to the present invention are defined herein. All combinations of at least two of the features described in the claims, the description and/or figures fall within the scope of the present invention.

In a first embodiment of the present invention, it is provided that a separate, first insulation element, which is electrically non-conductive but provides good thermal conductivity, is situated between the cell bottom and the cooling element. In such an embodiment of the present invention, in addition to the desired electrical insulation, a particularly good heat dissipation is made possible in particular.

In a concrete embodiment of the first insulation element, in which it is relatively easily manufactured and has the desired electrical insulation and good thermal conduction properties, it is provided that the first insulation element is configured with passages for the fastening protrusion and may be made of plastic or ceramic.

A battery assembly, which is particularly stable mechanically and has good thermal conduction properties and in which high (electrical) insulation properties between the battery cells and the cooling element are also made possible, is achieved when the cooling element is made of metal, when the fastening protrusion and the clamping element are made of metal and when a second insulation element is situated between the fastening protrusion and the cooling element. The second insulation element produces electrical insulation between the fastening protrusion in the passage of the cooling element with respect to the cooling element.

It may particularly be the case that when the second insulation element is configured as an insulating bushing and has a flange-shaped peripheral edge which is situated between the cooling element and the clamping element. This therefore permits electrical insulation between the clamping element and the cooling element without any additional components.

In an alternative embodiment of the present invention, in addition to the fundamental possibility described so far for manufacturing the cooling element of metal in particular, there is also the option of forming the cooling element of a plastic having a good thermal conductivity. The advantage of configuring the cooling element made of a plastic having a good thermal conductivity is that electrical insulation properties are achieved even through the choice of material, so that additional measures are not usually needed for electrical insulation between the battery cells and the cooling element.

To permit a particularly good heat transfer between the cell housing of the battery cells and the cooling element, it is provided here that the cooling element should have at least one, which may be two, side walls integrally molded in one piece on a bottom area, these side walls being in surface contact with at least one side wall of the cell housing. A larger heat transfer area is thus achieved in comparison with an approach in which only the cell bottom is connected to the cooling element, and local thermal overloading of the battery cells is thus also avoided.

A particularly good and secure contact of the side walls with the corresponding surfaces of the cell housing is achieved when two side walls are provided and when the cooling element has a conical cross section.

In addition, improved heat dissipation on the cooling element is basically achieved when cooling ducts are formed in the cooling element.

A particularly simple fastening of the cell housings of the battery cells without the use of specially configured clamping elements is achieved when the fastening protrusion has a thread which cooperates with a corresponding (standardized) clamping nut.

Additional features, advantages and details of the present invention are derived from the following description of exemplary embodiments and on the basis of the drawings.

### BRIEF DESCRIPTION OF THE DRAWINGS

FIG. 1 shows a perspective partial view of a battery assembly according to the present invention in a first embodiment of the present invention in a partially sectional diagram.

FIG. 2 shows a longitudinal section through the battery assembly according to FIG. 1 in the area of a fastening protrusion in an embodiment modified in comparison with FIG. 1, using an insulating bushing.

FIG. 3 shows a battery assembly, which has been modified in comparison with FIG. 1 using a trough-shaped cooling housing made of plastic in a sectional perspective view.

### DETAILED DESCRIPTION

The same components or components having the same function are provided with the same reference numerals in the figures.

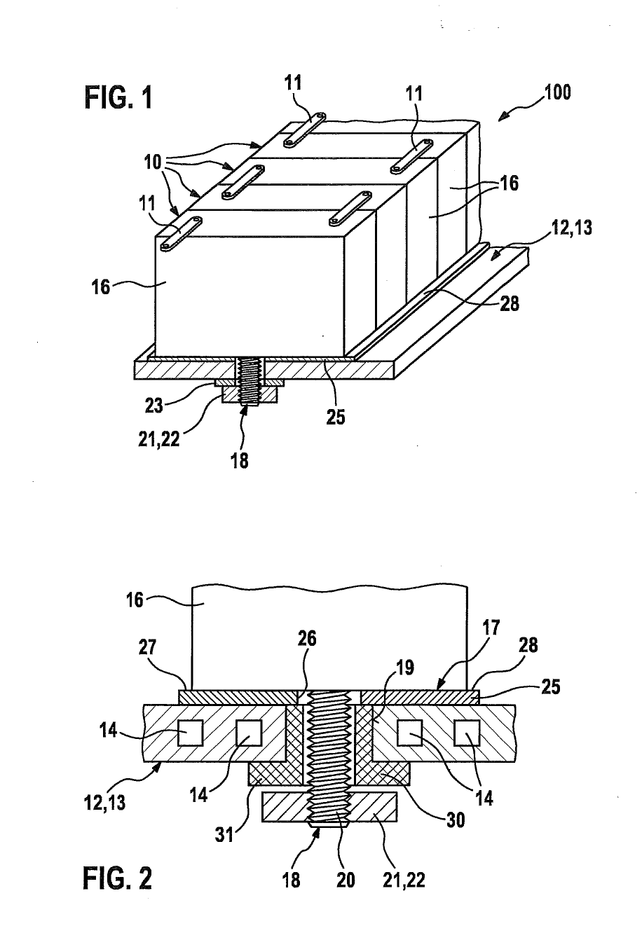

FIG. 1 shows a first battery assembly 100 according to the present invention, which is used in particular but not restrictively as a component of a power supply system in a hybrid vehicle, for supplying energy to at least one electric drive motor. Battery assembly 100 includes a plurality of battery cells 10, which are usually configured to be identical, connected electrically in series or in parallel, depending on the requirements, via cell connectors 11. It may of course also be provided that multiple battery assemblies 100 are provided which in turn are electrically interconnected. In practice, the power supply in a hybrid vehicle may include approximately 100 battery cells 10, for example, which cooperate with each other.

To divert the heat loss caused in particular by the current drain from battery cells 10 due to chemical processes from individual battery cells 10 to thereby prevent any thermal damage or overload on battery cells 10, a cooling element 12 in the form of a metallic cooling plate 13 is provided. Cooling plate 13 may in turn be connected to the body of the motor vehicle, for example, in an essentially known manner. FIG. 2 also shows cooling ducts 14 optionally situated inside cooling plate 13, cooling air or better still a liquid coolant being conducted through these cooling ducts.

To connect individual battery cells 10 to cooling element 12 or to cooling plate 13, the prismatic cell housing 16 of battery cell 10 has a pin-shaped fastening protrusion 18 on the underside, cell bottom 17, which faces cooling plate 13. It should be pointed out here that cell housing 16 and fastening protrusion 18 are made of metal, cell housing 16 together with fastening protrusion 18 being manufactured in one piece by extrusion, for example. The connection between individual battery cells 10 and cooling plate 13 also ensures good heat transmission, i.e., a good heat transfer between battery cells 10 and cooling plate 13, in addition to the mechanical fastening of battery cells 10 inside the motor vehicle. It is necessary here for cell housing 16 and cell bottoms 17 to sit, which may be all-over, on cooling plate 13. This is made possible by applying an axial clamping force between cell housing 16 and cooling plate 13. For this purpose, fastening protrusions 18, which protrude through corresponding passages 19 in cooling plate 13, each have an outer thread 20, which cooperates with a clamping element 22 configured as a clamping nut 21. A washer 23 may also be provided between clamping nut 21 and the underside of cooling plate 13.

In addition to good heat transfer between battery cells 10 and cooling plate 13, electrical insulation of battery cells 10 with respect to cooling element 12 made of metal may additionally be necessary. It may therefore be provided that cell housing 16 and cooling plate 13 are coated with a corresponding insulation layer, if necessary, at least on the side facing battery cells 10. According to the present invention, it is provided that an additional first insulation element 25 is situated between cooling plate 13 or cooling element 12 and cell bottom 17 of battery cells 10. Additional first insulation element 25, which is discernible in FIG. 2 in particular, is configured in the form of a plate having a hole 26 in the area of fastening protrusion 18. In the exemplary embodiment illustrated here, additional insulation element 25 extends beyond cell housing 16 in boundary areas 27, 28. Additional insulation element 25 may either be adapted to the size of a single battery cell 10 or may be of such a size that all battery cells 10 situated inside a battery assembly 100 or a subset thereof is/are electrically insulated with respect to cooling plate 13 via a shared additional first insulation element 25. The material of additional insulation element 25 may also be good heat-conductive in addition to the desired electrical insulation properties. Good heat-conductive plastics and ceramic materials in particular are suitable for additional insulation element 25 for this purpose.

A particularly good electrical insulation of battery cells 10 with respect to cooling plate 13 is achieved when an insulating bushing 30, which functions as a second insulation element and electrically insulates fastening protrusion 18 according to FIG. 2 on its perimeter relative to passage 19, is used for fastening protrusion 18 in the opening cross section of passage 19. In particular, insulating bushing 30 may have a flange-type peripheral edge 31 on the side facing clamping nut 21 at which clamping nut 21 is in contact during axial clamping of battery cell 10 against cooling plate 13. Insulating bushing 30 and edge 31 therefore make it possible to eliminate an additional washer 23, so that electrical insulation of the clamping nut 21 made of metal with respect to cooling plate 13 is made possible by all-over contact of clamping nut 21 with edge 31.

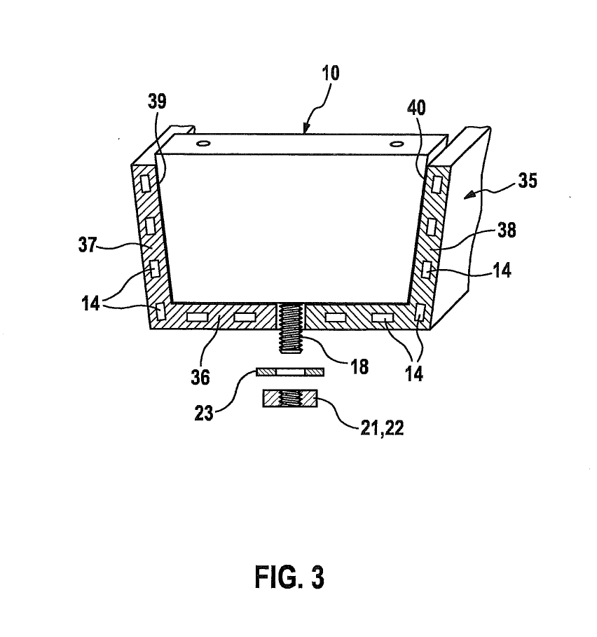

In the modified exemplary embodiment of the present invention shown in FIG. 3, a cup-shaped or trough-shaped cooling housing 35 is used as cooling element 12 instead of a cooling plate 13. Cooling housing 35 has a planar bottom 36 and two side walls 37, 38 extending upward in one piece from bottom 36. It may be provided that side walls 37, 38 are situated slightly obliquely to the vertical, the cross section of cooling housing 35 thus being conical. It is sufficient if side walls 37, 38 are perpendicular to the vertical by a small angle of 1° to 5°, for example. Cooling ducts 14 may be formed not only in bottom 36 in cooling housing 35 but also in the area of two side walls 37, 38. A cooling housing 35 configured in this way permits an enlarged heat transfer area since not only is cell bottom 17 of battery cell 10 in operative connection with cooling element 12, but side walls 39, 40 of battery cell 10 are also in operative connection. Cooling housing 35 is made of an electrically insulating plastic, which has a good thermal conductivity. Due to the configuration of cooling housing 35 made of an electrically good insulating plastic and having corresponding passages 19 on bottom 36 for fastening protrusions 18, it is not necessary to provide additional electrical insulation for fastening protrusion 18 with respect to cooling housing 35, as is made possible via insulating bushing 30. In fact, a clamping nut 21 made of metal and a washer 23 made of metal may be used.

Battery assemblies 100 described so far may be modified in a variety of ways without departing from the scope of the present invention.

1-10. (canceled)

11. A battery assembly, comprising:
multiple battery cells, each of the battery cells having a cell housing and being electrically interconnected, each cell housing having at least one fastening protrusion on a cell bottom, which protrudes through an opening in a cooling element configured as a cooling plate or as a cooling housing for the cell housing, the fastening protrusion cooperating with a clamping element which clamps the cell housing against the cooling element;
wherein the cell bottom is electrically insulated with respect to the cooling element in addition to a coating, which is present, if necessary, on the cell housing and/or on the cooling element.

12. The battery assembly of claim 11, wherein a separate first insulation element, which is electrically non-conductive but provides good thermal conductivity, is situated between the cell bottom and the cooling element.

13. The battery assembly of claim 12, wherein the first insulation element is in the form of a plate having at least one passage for the fastening protrusion and made of plastic or ceramic in particular.

14. The battery assembly of claim 11, wherein the cooling element is made of metal, wherein the fastening protrusion and the clamping element are made of metal, and wherein a second insulation element is situated between the fastening protrusion and the cooling element.

15. The battery assembly of claim 14, wherein the second insulation element includes an insulating bushing and has a peripheral flange-type edge, which is situated between the cooling element and the clamping element.

16. The battery assembly of claim 11, wherein the cooling element includes a trough-shaped cooling housing in cross section and/or is made of a plastic having a good thermal conductivity.

17. The battery assembly of claim 16, wherein the cooling housing has at least one side wall integrally molded in one piece to the bottom forming a surface contact with at least one side wall of the cell housing.

18. The battery assembly of claim 17, wherein two side walls are provided, and the cooling housing has a conical cross section in which the side walls are situated obliquely with respect to the vertical.

19. The battery assembly of claim 11, wherein cooling ducts are formed in the cooling element.

20. The battery assembly of claim 11, wherein the fastening protrusion has an outside thread and the clamping element is a clamping nut.

21. The battery assembly of claim 16, wherein the cooling housing has at least two side walls integrally molded in one piece to the bottom forming a surface contact with at least one side wall of the cell housing.

22. The battery assembly of claim 21, wherein two side walls are provided, and the cooling housing has a conical cross section in which the side walls are situated obliquely with respect to the vertical.

23. The battery assembly of claim 11, wherein each of the battery cells have a prismatic cell housing, and wherein the cell bottom is electrically insulated with respect to the cooling element in addition to a coating on the cell housing and/or on the cooling element.

24. The battery assembly of claim 11, wherein each of the battery cells have a prismatic cell housing.

25. The battery assembly of claim 11, wherein the cell bottom is electrically insulated with respect to the cooling element in addition to a coating on the cell housing and/or on the cooling element.
